(19) United States
(12) Patent Application Publication
(10) Pub. No.: US 2026/0052494 A1
(43) Pub. Date: Feb. 19, 2026

(54) INDICATING RAT GENERATIONS

(71) Applicant: Samsung Electronics Co., Ltd., Suwon-si (KR)

(72) Inventors: Hongbo Si, Allen, TX (US); Ebrahim MolavianJazi, San Jose, CA (US)

(21) Appl. No.: 19/283,157

(22) Filed: Jul. 28, 2025

Related U.S. Application Data
(60) Provisional application No. 63/683,977, filed on Aug. 16, 2024.

(51) Int. Cl. H04W 56/00; H04B 7/06; H04L 5/00

(52) U.S. Cl. CPC H04W 56/0015; H04B 7/06968; H04L 5/0007

(57) ABSTRACT

Apparatuses and methods for indicating radio access technology (RAT) generations. A method of a user equipment (UE) in a wireless communication system includes receiving a synchronization signals and physical broadcast channel (SS/PBCH) block including a primary synchronization signal (PSS) and a secondary synchronization signal (SSS) and identifying resources for a tertiary synchronization signal (TSS) associated with the SS/PBCH block. The method further includes identifying whether the TSS is present in the resources and determining to operate the wireless communication system with a first RAT when the TSS is present and a second RAT when the TSS is not present.

### CROSS-REFERENCE TO RELATED AND CLAIM OF PRIORITY

The present application claims priority under 35 U.S.C. § 119(e) to U.S. Provisional Ser. No. 63/683,977 filed on Aug. 16, 2024, which is hereby incorporated by reference in its entirety.

### TECHNICAL FIELD

The present disclosure relates generally to wireless communication systems and, more specifically, the present disclosure is related to apparatuses and methods for indicating radio access technology (RAT) generations.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to for indicating RAT generations.

In one embodiment, a user equipment (UE) in a wireless communication system is provided. The UE includes a transceiver configured to receive a synchronization signals and physical broadcast channel (SS/PBCH) block including a primary synchronization signal (PSS) and a secondary synchronization signal (SSS) and a processor operably coupled to the transceiver. The processor is configured to identify resources for a tertiary synchronization signal (TSS) associated with the SS/PBCH block, identify whether the TSS is present in the resources, and determine to operate the wireless communication system with a first RAT when the TSS is present and a second RAT when the TSS is not present.

In another embodiment, a base station (BS) in a wireless communication system is provided. The BS includes a processor configured to determine resources for a TSS associated with a SS/PBCH block and determine to operate the wireless communication system with a first RAT or a second RAT. The SS/PBCH block includes a PSS and a SSS. The BS further includes a transceiver operably coupled to the processor. The transceiver is configured to transmit the SS/PBCH block, transmit the TSS in the resources when the wireless communication system operates with the first RAT, and not transmit the TSS in the resources when the wireless communication system operates with the second RAT.

In yet another embodiment, a method of a UE in a wireless communication system is provided. The method includes receiving a SS/PBCH block including a PSS and a SSS and identifying resources for a TSS associated with the SS/PBCH block. The method further includes identifying whether the TSS is present in the resources and determining to operate the wireless communication system with a first RAT when the TSS is present and a second RAT when the TSS is not present.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example synchronization signal/physical broadcast channel (SS/PBCH) block architecture according to embodiments of the present disclosure;

FIG. 6 illustrates an example SS/PBCH block time domain pattern according to embodiments of the present disclosure;

FIG. 7 illustrates example time locations for synchronization signal block (SSB) and tertiary synchronization signal (TSS) according to embodiments of the present disclosure;

FIG. 8 illustrates example time locations for SSB and TSS according to embodiments of the present disclosure;

FIG. 9 illustrates example time locations for SSB and TSS according to embodiments of the present disclosure; and

FIG. 10 illustrates an example UE procedure for determining information carried by a TSS according to embodiments of the present disclosure.

### DETAILED DESCRIPTION

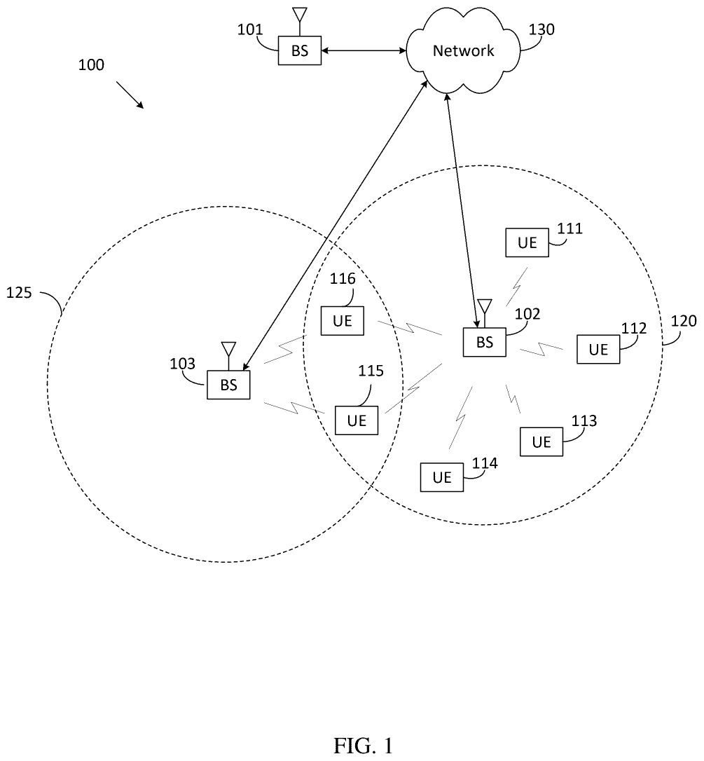

FIGS. 1-10, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.0.0, “NR; Physical channels and modulation;” [REF 2] 3GPP TS 38.212 v18.0.0, “NR; Multiplexing and channel coding;” [REF 3] 3GPP TS 38.213 v18.0.0, “NR; Physical layer procedures for control;” [REF 4] 3GPP TS 38.214 v18.0.0, “NR; Physical layer procedures for data;” and [REF 5] 3GPP TS 38.331 v18.0.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to identify an indication of RAT generations. In certain embodiments, one or more of the BSs 101-103 include circuitry, programing, or a combination thereof to support indicating RAT generations.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

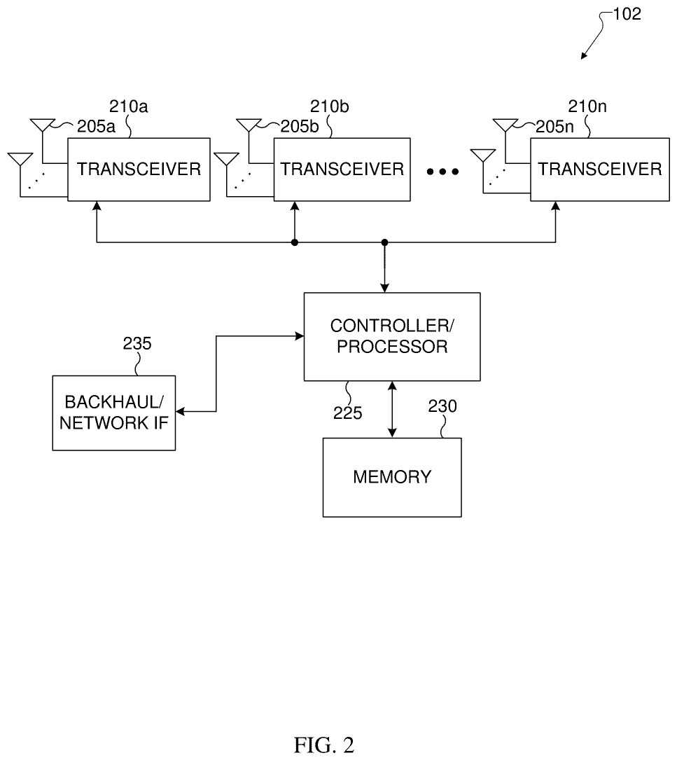

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for indicating RAT generations. Any of a wide variety of other functions could be supported in the gNB 102 by the controller/processor 225.

The controller/processor 225 is also capable of executing programs and other processes resident in the memory 230, such as processes related to indicating RAT generations. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

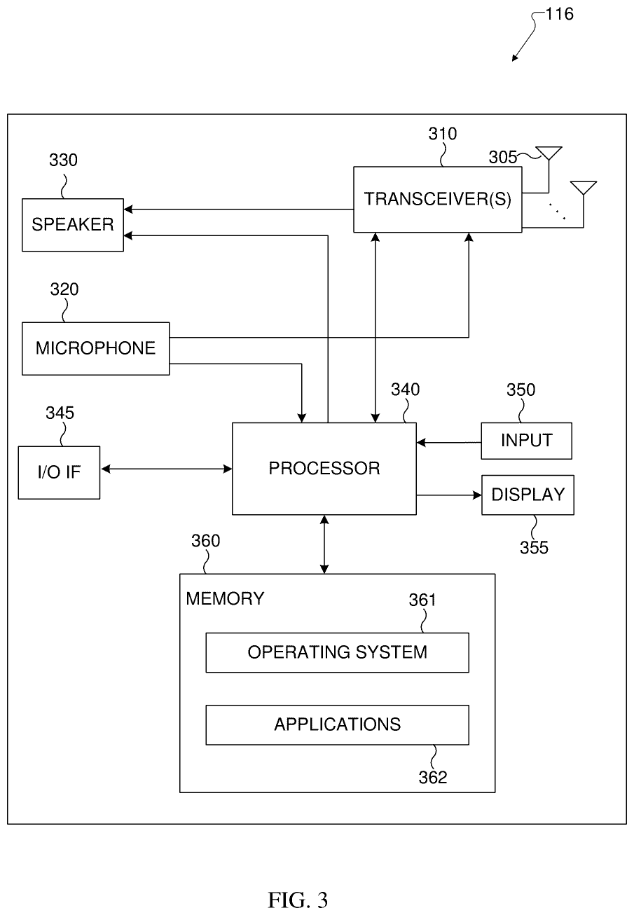

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for identify an indication of RAT generations as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

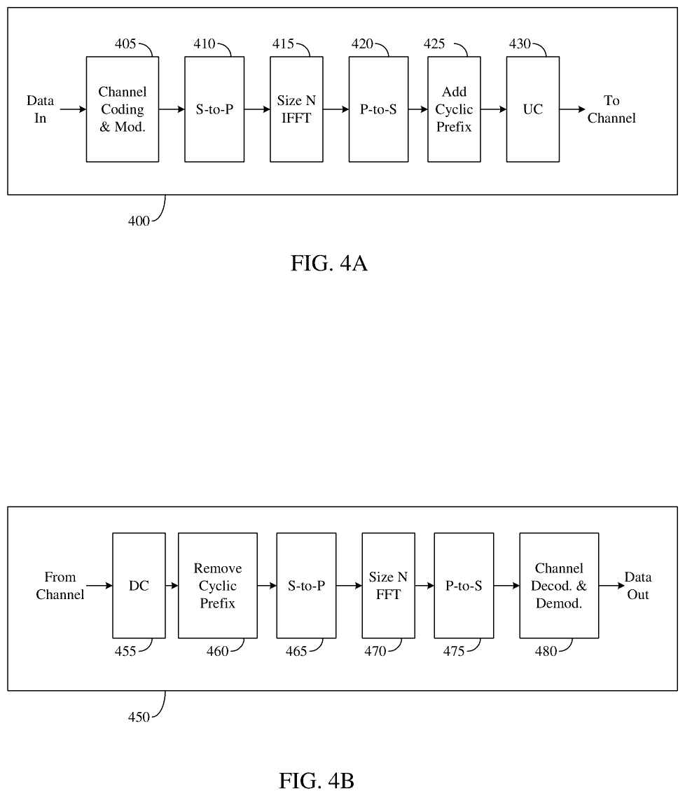

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for identifying an indication of RAT generations as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

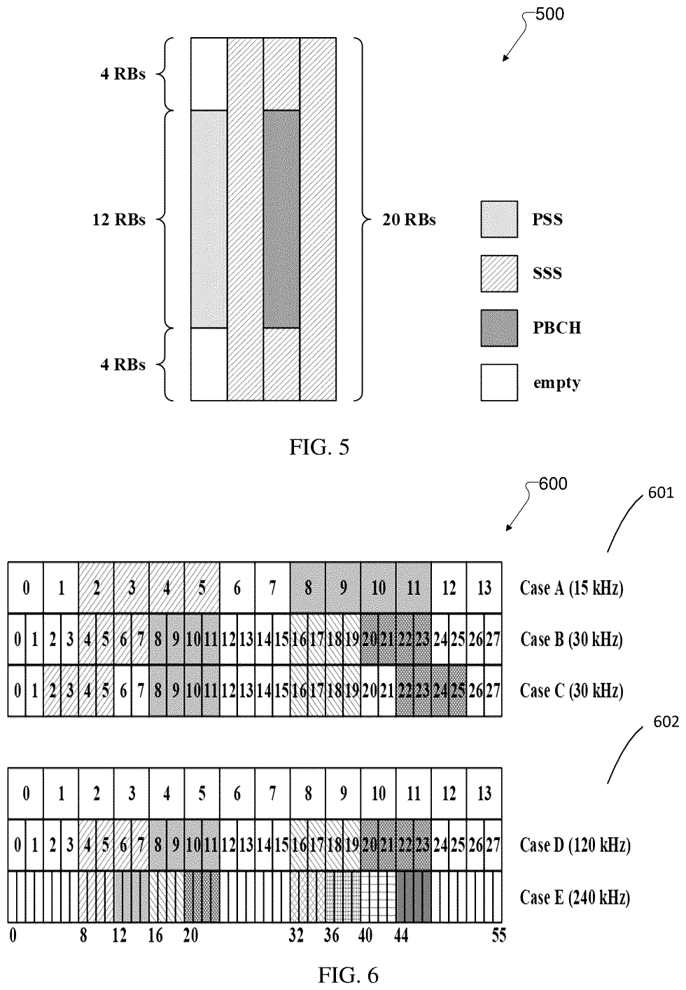

FIG. 5 illustrates an example SS/PBCH block architecture 500 according to embodiments of the present disclosure. For example, SS/PBCH block architecture 500 can be received by any of the UEs 111-116 of FIG. 1. This example is for illustration only and other embodiments can be used without departing from the scope of the present disclosure.

In NR Rel-15, each synchronization signals and physical broadcast channel (SS/PBCH) block compromises of four consecutive orthogonal frequency division multiplexing (OFDM) symbols, wherein the center 12 RBs of the first symbol are mapped for primary synchronization signal (PSS), the second and forth symbols are mapped for PBCH, and the third symbol is mapped for both secondary synchronization signal (SSS) and PBCH. An illustration of the SS/PBCH block composition is shown in FIG. 5. The same SS/PBCH composition is applied to supported carrier frequency ranges in NR, which spans from 0.41 GHz to 7.125 GHz as Frequency Range 1 (FR1), and spans from 24.25 to 52.6 GHz as Frequency Range 2 (FR2). In every RB mapped for PBCH, 3 out of the 12 resource elements (REs) are mapped for the demodulation reference signal (DM-RS) of PBCH, wherein the 3 REs are uniformly distributed in the RB and the starting location of the first RE is based on cell identity (ID).

NR Rel-15 supports one or two subcarrier spacing (SCS) for SS/PBCH block, for a given band, wherein the same SCS is applied to PSS, SSS, and PBCH (including its DM-RS). For FR1, 15 kHz and/or 30 kHz can be applied to SS/PBCH block, and for FR2, 120 kHz and/or 240 kHz can be applied to SS/PBCH block.

FIG. 6 illustrates an example SS/PBCH block time domain pattern 600 according to embodiments of the present disclosure. For example, SS/PBCH block time domain pattern 600 can be utilized by any of the UEs 111-116 of FIG. 1. This example is for illustration only and other embodiments can be used without departing from the scope of the present disclosure.

NR Rel-15 also supports multiple candidate SS/PBCH blocks within a time unit of half frame, wherein the time unit repeats in time domain with a configurable periodicity. The time domain pattern of SS/PBCH blocks to at least one slot is illustrated in FIG. 6. For FR1 (601), the SS/PBCH block pattern is designed according to 15 kHz as the reference SCS, and for FR2 (602), the SS/PBCH block pattern is designed according to 60 kHz as the reference SCS.

With refence to FIG. 6, an example SS/PBCH block time domain pattern in slot(s) is shown.

For a new generation of wireless communication, there can be an implementation that both 5G and 6G radio access technologies (RATs) are on the same band. Embodiments of the present disclosure recognize that, for those implementation(s), there is a need for the UE to distinguish 5G or 6G, and this disclosure focuses on schemes for indicating 5G or 6G.

This disclosure focuses on the indication of 5G and 6G using signal(s) in SS/PBCH block or a new signal associated with the SS/PBCH block. More precisely, the following aspects are covered by the disclosure.
Using 5G signal in a SS/PBCH block for indication of 5G and 6G
Using 6G signal, e.g., associated with a SS/PBCH block, for indication of 5G and 6G
   Resources for the 6G signal
   Sequence generation for the 6G signal
   Indication of information carried by the 6G signal
   Example UE procedure In one embodiment, a signal in 5G synchronization signals and physical broadcast channel (SS/PBCH) block (or short for SSB) can carry the information that the cell or carrier or band that includes the SS/PBCH block is with 5G or 6G.

For one example, a frequency location of the SS/PBCH block can be used for the indication. For instance, if a frequency location of SS/PBCH block is determined from a first set of values, e.g., 5G synchronization raster entries, the SS/PBCH block corresponds to 5G; if the frequency location of SS/PBCH block is determined from a second set of values, e.g., 6G synchronization raster entries, the SS/PBCH block corresponds to 6G; e.g., wherein the first set of values and the second set of values do not overlap.

For another example, a cell ID carried by signal(s) in the SS/PBCH block (e.g., PSS and/or SSS) can be used for the indication. For instance, if a cell ID belongs to a first set of values, the SS/PBCH block corresponds to 5G; and if the cell ID belongs to a second set of values, the SS/PBCH block corresponds to 6G; e.g., wherein the first set of values and the second set of values do not overlap.

For yet another example, a primary synchronization signal (PSS) in the SS/PBCH block can be used for the indication. For instance, if a PSS sequence is selected from a first set, the SS/PBCH block corresponds to 5G; and if the PSS sequence is selected from a second set, the SS/PBCH block corresponds to 6G; e.g., wherein the first set of sequences and the second set of sequences do not overlap.
For one sub-example, the generation function for the M-sequence(s) for 5G PSS sequence(s) can be different from the generation function for the M-sequence(s) for 6G PSS sequence(s). For instance, the generation function for the M-sequence(s) for 6G PSS sequence(s) can be x(i+7)=(x(i+3)+x(i))mod 2, or x(i+7)=(x(i+6)+x(i))mod 2, or x(i+7)=(x(i+1)+x(i))mod 2.
For another sub-example, the cyclic shift(s) for the M-sequence(s) for 5G PSS sequence(s) can be different from the cyclic shift(s) for the M-sequence(s) for 6G PSS sequence(s). For instance, the cyclic shift(s) for the M-sequence(s) for 6G PSS sequence(s) have a constant offset value from the cyclic shift(s) for the M-sequence(s) for 5G PSS sequence(s), e.g., potentially subject to a modulo operation of the sequence length, such as the constant offset value is 21 or 22.
For yet another sub-example, the initial condition(s) for the M-sequence(s) for 5G PSS sequence(s) can be different from the initial condition(s) for the M-sequence(s) for 6G PSS sequence(s). For instance, the initial condition(s) for the M-sequence(s) for 6G PSS sequence(s) have a constant offset value from the initial condition(s) for the M-sequence(s) for 5G PSS sequence(s), e.g., potentially subject to a modulo operation of the sequence length, such as the constant offset value is 21 or 22.

For yet another example, a mapping order of a primary synchronization signal (PSS) in the SS/PBCH block to the corresponding resource elements (REs) can be used for the indication. For instance, if a PSS sequence is mapped from lowest to highest in the frequency domain, the SS/PBCH block corresponds to 5G; and if the PSS sequence is mapped from highest to lowest in the frequency domain, the SS/PBCH block corresponds to 6G.

For yet another example, a secondary synchronization signal (SSS) in the SS/PBCH block can be used for the indication. For instance, if a SSS sequence is selected from a first set, the SS/PBCH block corresponds to 5G; and if the SSS sequence is selected from a second set, the SS/PBCH block corresponds to 6G; e.g., wherein the first set of sequences and the second set of sequences do not overlap.
For one sub-example, at least one generation function for the M-sequence(s) for 5G SSS sequence(s) can be different from at least one generation function for the M-sequence(s) for 6G SSS sequence(s). For instance, at least one generation function for the M-sequence(s) for 6G SSS sequence(s) can be x(i+7)=(x(i+3)+x(i))mod 2, or x(i+7)=(x(i+6)+x(i))mod 2.
For another sub-example, the cyclic shift(s) for at least one of the M-sequence(s) for 5G SSS sequence(s) can be different from the cyclic shift(s) for at least one of the M-sequence(s) for 6G SSS sequence(s). For instance, the cyclic shift(s) for at least one of the M-sequence(s) for 6G SSS sequence(s) have a constant offset value from the cyclic shift(s) for at least one of the M-sequence(s) for 5G SSS sequence(s), e.g., potentially subject to a modulo operation of the sequence length, such as the constant offset value is 2 or 3.
For yet another sub-example, the initial condition(s) for at least one of the M-sequence(s) for 5G SSS sequence(s) can be different from the initial condition(s) for at least one of the M-sequence(s) for 6G SSS sequence(s). For instance, the initial condition(s) for at least one of the M-sequence(s) for 6G SSS sequence(s) have a constant offset value from the initial condition(s) for at least one of the M-sequence(s) for 5G SSS sequence(s), e.g., potentially subject to a modulo operation of the sequence length, such as the constant offset value is 2 or 3.

For yet another example, a mapping order of a secondary synchronization signal (SSS) in the SS/PBCH block to the corresponding REs can be used for the indication. For instance, if a SSS sequence is mapped from lowest to highest in the frequency domain, the SS/PBCH block corresponds to 5G; and if the SSS sequence is mapped from highest to lowest in the frequency domain, the SS/PBCH block corresponds to 6G.

For yet another example, a multiplexing pattern between a PSS and a SSS in the SS/PBCH block can be used for the indication. For instance, if PSS is mapped to the first symbol in the SS/PBCH block and SSS is mapped to the third symbol in the SS/PBCH block, the SS/PBCH block corresponds to 5G; and if PSS and SSS are mapped in a different way (e.g., PSS is mapped to the first symbol and SSS is mapped to a symbol different from the third symbol, such as the second symbol), the SS/PBCH block corresponds to 6G.

For yet another example, a demodulation reference signal (DM-RS) of PBCH in the SS/PBCH block can be used for the indication. For instance, if a DM-RS sequence is selected from a first set, the SS/PBCH block corresponds to 5G; and if the DM-RS sequence is selected from a second set, the SS/PBCH block corresponds to 6G; e.g., wherein the first set of sequences and the second set of sequences do not overlap. For instance, the initial condition for a pseudo random (PN) sequence generating the DM-RS of PBCH for the SS/PBCH block corresponds to 5G can be different from the initial condition for a PN sequence generating the DM-RS of PBCH for the SS/PBCH block corresponds to 6G, such as with a constant offset value.

For yet another example, a mapping order of a demodulation reference signal (DM-RS) of PBCH in the SS/PBCH block to the corresponding REs can be used for the indication. For instance, if a DM-RS sequence is mapped from lowest to highest in the frequency domain, the SS/PBCH block corresponds to 5G; and if the DM-RS sequence is mapped from highest to lowest in the frequency domain, the SS/PBCH block corresponds to 6G.

For yet another example, locations of the REs mapped for a demodulation reference signal (DM-RS) of PBCH in the SS/PBCH block can be used for the indication. For instance, if a DM-RS sequence is mapped to a first set of REs, the SS/PBCH block corresponds to 5G; and if the DM-RS sequence is mapped to a second set of REs, the SS/PBCH block corresponds to 6G; e.g., wherein the first set of REs and the second set of REs do not overlap or do not be fully same.

For yet another example, a scrambling sequence of PBCH in the SS/PBCH block can be used for the indication. For instance, if a scrambling sequence is selected from a first set, the SS/PBCH block corresponds to 5G; and if the scrambling sequence is selected from a second set, the SS/PBCH block corresponds to 6G; e.g., wherein the first set of sequences and the second set of sequences do not overlap.

In one embodiment, a new signal in 6G can carry the information that the cell or carrier or band that includes the SS/PBCH block is with 5G or 6G. For instance, the new signal can be denoted as additional synchronization signal (ASS), or tertiary synchronization signal (TSS).

In one sub-embodiment, time domain and/or frequency domain and/or power domain and/or spatial domain resource information for the TSS can be determined by the UE.

For one example, TSS can be time division multiplexed (TDMed) with 5G SS/PBCH block.

For another example, TSS can occupy one OFDM symbol in the time domain, e.g., within the bandwidth of SS/PBCH block.

For yet another example, time domain resources for TSS can be pre-determined for a case of SS/PBCH block pattern in a half frame.

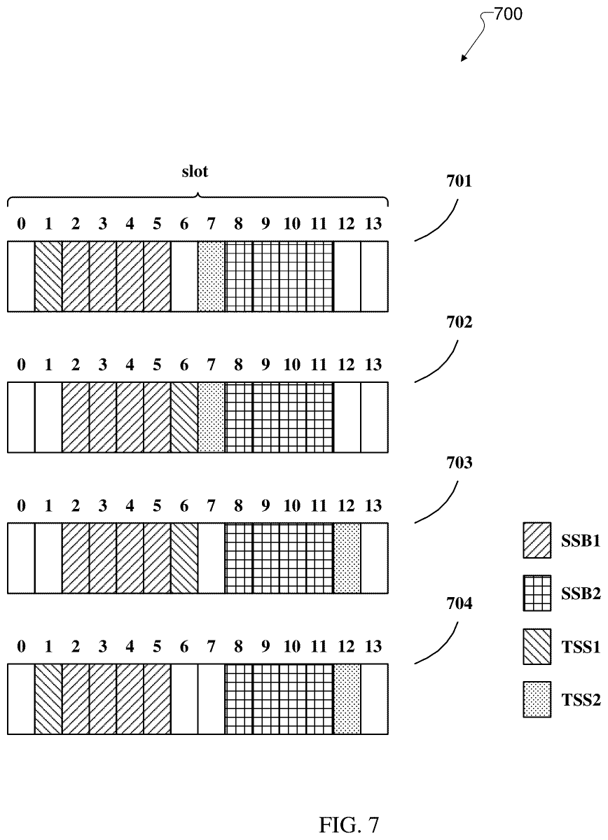

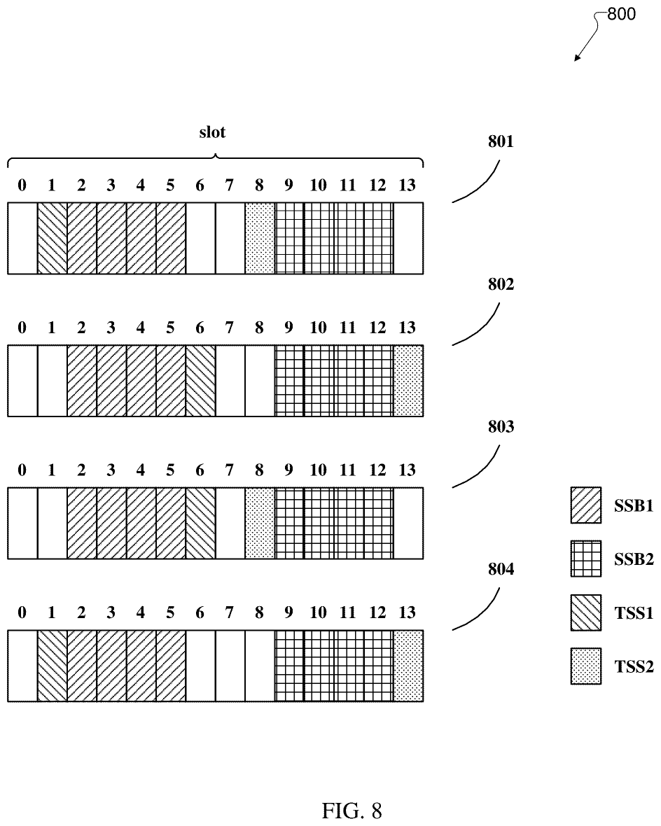

FIG. 7 illustrates example time locations 700 for SSB and TSS according to embodiments of the present disclosure. For example, time locations 700 can be utilized by any of the UEs 111-116 of FIG. 1, such as the UE 111. This example is for illustration only and other embodiments can be used without departing from the scope of the present disclosure.

For one sub-example, if the case of SS/PBCH block pattern in a half frame corresponds to {2, 8}+14·n, wherein n is a slot index, and two candidate SS/PBCH blocks in a slot starts from OFDM symbol 2 and 8, respectively, the location of TSS(s) in the slot can be according to an instance of FIG. 7.
For one instance (701 in FIG. 7), the TSS associated with the first candidate SS/PBCH block can be in OFDM symbol 1, and the TSS associated with the second candidate SS/PBCH block can be in OFDM symbol 7.
For another instance (702 in FIG. 7), the TSS associated with the first candidate SS/PBCH block can be in OFDM symbol 6, and the TSS associated with the second candidate SS/PBCH block can be in OFDM symbol 7.
For yet another instance (703 in FIG. 7), the TSS associated with the first candidate SS/PBCH block can be in OFDM symbol 6, and the TSS associated with the second candidate SS/PBCH block can be in OFDM symbol 12.
For yet another instance (704 in FIG. 7), the TSS associated with the first candidate SS/PBCH block can be in OFDM symbol 1, and the TSS associated with the second candidate SS/PBCH block can be in OFDM symbol 12.

With reference to FIG. 7, an example of time location of TSS for a first case of SSB pattern is shown.

FIG. 8 illustrates example time locations 800 for SSB and TSS according to embodiments of the present disclosure. For example, time locations 800 can be utilized by any of the UEs 111-116 of FIG. 1, such as the UE 112. This example is for illustration only and other embodiments can be used without departing from the scope of the present disclosure.

For another sub-example, if the case of SS/PBCH block pattern in a half frame corresponds to {2, 9}+14·n, wherein n is a slot index, and two candidate SS/PBCH blocks in a slot starts from OFDM symbol 2 and 9, respectively, the location of TSS(s) in the slot can be according to an instance of FIG. 8.
For one instance (801 in FIG. 8), the TSS associated with the first candidate SS/PBCH block can be in OFDM symbol 1, and the TSS associated with the second candidate SS/PBCH block can be in OFDM symbol 8.
For another instance (802 in FIG. 8), the TSS associated with the first candidate SS/PBCH block can be in OFDM symbol 6, and the TSS associated with the second candidate SS/PBCH block can be in OFDM symbol 13.
For yet another instance (803 in FIG. 8), the TSS associated with the first candidate SS/PBCH block can be in OFDM symbol 6, and the TSS associated with the second candidate SS/PBCH block can be in OFDM symbol 8.
For yet another instance (804 in FIG. 8), the TSS associated with the first candidate SS/PBCH block can be in OFDM symbol 1, and the TSS associated with the second candidate SS/PBCH block can be in OFDM symbol 13.

With refence to FIG. 8, an example of time location of TSS for a second case of SSB pattern is shown.

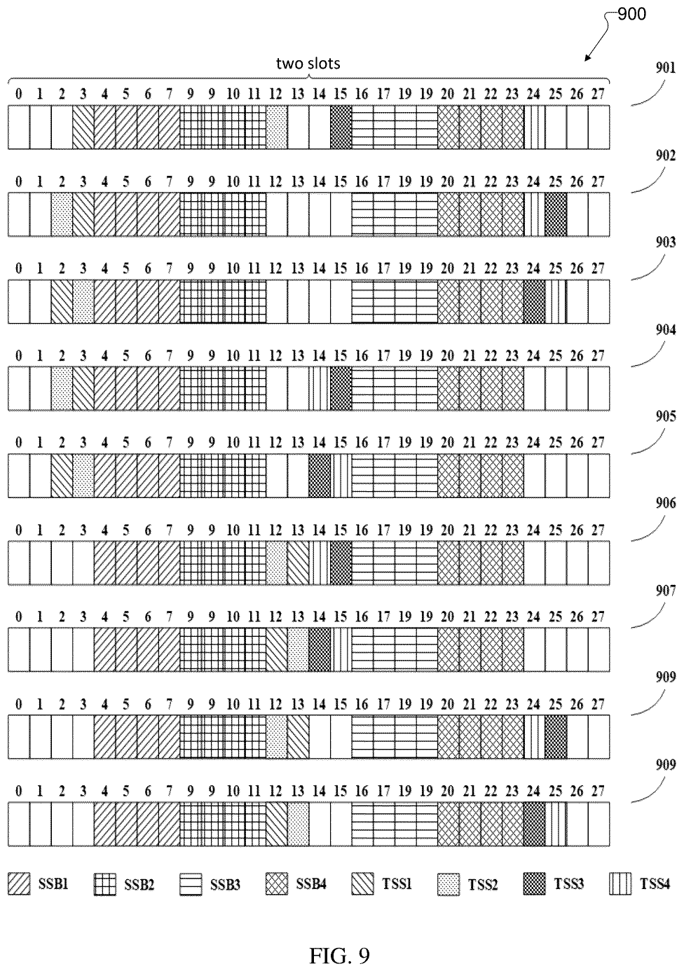

FIG. 9 illustrates example time locations 900 for SSB and TSS according to embodiments of the present disclosure. For example, time locations 900 can be utilized by any of the UEs 111-116 of FIG. 1, such as the UE 116. This example is for illustration only and other embodiments can be used without departing from the scope of the present disclosure.

For yet another sub-example, if the case of SS/PBCH block pattern in a half frame corresponds to {4, 8, 16, 20}+28·n, wherein n is an index for a group of two slots, and four candidate SS/PBCH blocks in a group of two slot starts from OFDM symbol 4, 8, 16, and 20, respectively, the location of TSS(s) in the slot can be according to an instance of FIG. 9.
For one instance (901 in FIG. 9), the TSS associated with the first candidate SS/PBCH block can be in OFDM symbol 3, the TSS associated with the second candidate SS/PBCH block can be in OFDM symbol 12, the TSS associated with the third candidate SS/PBCH block can be in OFDM symbol 15, the TSS associated with the fourth candidate SS/PBCH block can be in OFDM symbol 24.
For another instance (902 in FIG. 9), the TSS associated with the first candidate SS/PBCH block can be in OFDM symbol 3, the TSS associated with the second candidate SS/PBCH block can be in OFDM symbol 2, the TSS associated with the third candidate SS/PBCH block can be in OFDM symbol 25, the TSS associated with the fourth candidate SS/PBCH block can be in OFDM symbol 24.
For yet another instance (903 in FIG. 9), the TSS associated with the first candidate SS/PBCH block can be in OFDM symbol 2, the TSS associated with the second candidate SS/PBCH block can be in OFDM symbol 3, the TSS associated with the third candidate SS/PBCH block can be in OFDM symbol 24, the TSS associated with the fourth candidate SS/PBCH block can be in OFDM symbol 25.
For yet another instance (904 in FIG. 9), the TSS associated with the first candidate SS/PBCH block can be in OFDM symbol 3, the TSS associated with the second candidate SS/PBCH block can be in OFDM symbol 2, the TSS associated with the third candidate SS/PBCH block can be in OFDM symbol 15, the TSS associated with the fourth candidate SS/PBCH block can be in OFDM symbol 14.
For yet another instance (905 in FIG. 9), the TSS associated with the first candidate SS/PBCH block can be in OFDM symbol 2, the TSS associated with the second candidate SS/PBCH block can be in OFDM symbol 3, the TSS associated with the third candidate SS/PBCH block can be in OFDM symbol 14, the TSS associated with the fourth candidate SS/PBCH block can be in OFDM symbol 15.
For yet another instance (906 in FIG. 9), the TSS associated with the first candidate SS/PBCH block can be in OFDM symbol 13, the TSS associated with the second candidate SS/PBCH block can be in OFDM symbol 12, the TSS associated with the third candidate SS/PBCH block can be in OFDM symbol 15, the TSS associated with the fourth candidate SS/PBCH block can be in OFDM symbol 14.
For yet another instance (907 in FIG. 9), the TSS associated with the first candidate SS/PBCH block can be in OFDM symbol 12, the TSS associated with the second candidate SS/PBCH block can be in OFDM symbol 13, the TSS associated with the third candidate SS/PBCH block can be in OFDM symbol 14, the TSS associated with the fourth candidate SS/PBCH block can be in OFDM symbol 15.
For yet another instance (908 in FIG. 9), the TSS associated with the first candidate SS/PBCH block can be in OFDM symbol 13, the TSS associated with the second candidate SS/PBCH block can be in OFDM symbol 12, the TSS associated with the third candidate SS/PBCH block can be in OFDM symbol 25, the TSS associated with the fourth candidate SS/PBCH block can be in OFDM symbol 24.
For yet another instance (909 in FIG. 9), the TSS associated with the first candidate SS/PBCH block can be in OFDM symbol 12, the TSS associated with the second candidate SS/PBCH block can be in OFDM symbol 13, the TSS associated with the third candidate SS/PBCH block can be in OFDM symbol 24, the TSS associated with the fourth candidate SS/PBCH block can be in OFDM symbol 25.

With reference to FIG. 9, an example of time location of TSS for a third case of SSB pattern is shown.

For yet another sub-example, if the case of SS/PBCH block pattern in a half frame corresponds to {8, 12, 16, 20, 32, 36, 40, 44}+56·n, wherein n is an index for a group of four slots, and eight candidate SS/PBCH blocks in a group of two slot starts from OFDM symbol 8, 12, 16, 20, 32, 36, 40, and 44, respectively, the location of TSS(s) in the slot can be according to an instance herein.
For one instance, the TSS associated with the first candidate SS/PBCH block can be in OFDM symbol 7, the TSS associated with the second candidate SS/PBCH block can be in OFDM symbol 6, the TSS associated with the third candidate SS/PBCH block can be in OFDM symbol 25, the TSS associated with the fourth candidate SS/PBCH block can be in OFDM symbol 24, the TSS associated with the fifth candidate SS/PBCH block can be in OFDM symbol 31, the TSS associated with the sixth candidate SS/PBCH block can be in OFDM symbol 30, the TSS associated with the seventh candidate SS/PBCH block can be in OFDM symbol 49, the TSS associated with the eighth candidate SS/PBCH block can be in OFDM symbol 48.
For another instance, the TSS associated with the first candidate SS/PBCH block can be in OFDM symbol 6, the TSS associated with the second candidate SS/PBCH block can be in OFDM symbol 7, the TSS associated with the third candidate SS/PBCH block can be in OFDM symbol 24, the TSS associated with the fourth candidate SS/PBCH block can be in OFDM symbol 25, the TSS associated with the fifth candidate SS/PBCH block can be in OFDM symbol 30, the TSS associated with the sixth candidate SS/PBCH block can be in OFDM symbol 31, the TSS associated with the seventh candidate SS/PBCH block can be in OFDM symbol 48, the TSS associated with the eighth candidate SS/PBCH block can be in OFDM symbol 49.
For yet another instance, the TSS associated with the first candidate SS/PBCH block can be in OFDM symbol 7, the TSS associated with the second candidate SS/PBCH block can be in OFDM symbol 6, the TSS associated with the third candidate SS/PBCH block can be in OFDM symbol 5, the TSS associated with the fourth candidate SS/PBCH block can be in OFDM symbol 4, the TSS associated with the fifth candidate SS/PBCH block can be in OFDM symbol 31, the TSS associated with the sixth candidate SS/PBCH block can be in OFDM symbol 30, the TSS associated with the seventh candidate SS/PBCH block can be in OFDM symbol 29, the TSS associated with the eighth candidate SS/PBCH block can be in OFDM symbol 28.
For yet another instance, the TSS associated with the first candidate SS/PBCH block can be in OFDM symbol 7, the TSS associated with the second candidate SS/PBCH block can be in OFDM symbol 4, the TSS associated with the third candidate SS/PBCH block can be in OFDM symbol 5, the TSS associated with the fourth candidate SS/PBCH block can be in OFDM symbol 6, the TSS associated with the fifth candidate SS/PBCH block can be in OFDM symbol 31, the TSS associated with the sixth candidate SS/PBCH block can be in OFDM symbol 28, the TSS associated with the seventh candidate SS/PBCH block can be in OFDM symbol 29, the TSS associated with the eighth candidate SS/PBCH block can be in OFDM symbol 30.
For yet another instance, the TSS associated with the first candidate SS/PBCH block can be in OFDM symbol 4, the TSS associated with the second candidate SS/PBCH block can be in OFDM symbol 5, the TSS associated with the third candidate SS/PBCH block can be in OFDM symbol 6, the TSS associated with the fourth candidate SS/PBCH block can be in OFDM symbol 7, the TSS associated with the fifth candidate SS/PBCH block can be in OFDM symbol 28, the TSS associated with the sixth candidate SS/PBCH block can be in OFDM symbol 29, the TSS associated with the seventh candidate SS/PBCH block can be in OFDM symbol 30, the TSS associated with the eighth candidate SS/PBCH block can be in OFDM symbol 31.
For yet another instance, the TSS associated with the first candidate SS/PBCH block can be in OFDM symbol 7, the TSS associated with the second candidate SS/PBCH block can be in OFDM symbol 6, the TSS associated with the third candidate SS/PBCH block can be in OFDM symbol 5, the TSS associated with the fourth candidate SS/PBCH block can be in OFDM symbol 4, the TSS associated with the fifth candidate SS/PBCH block can be in OFDM symbol 51, the TSS associated with the sixth candidate SS/PBCH block can be in OFDM symbol 50, the TSS associated with the seventh candidate SS/PBCH block can be in OFDM symbol 49, the TSS associated with the eighth candidate SS/PBCH block can be in OFDM symbol 48.
For yet another instance, the TSS associated with the first candidate SS/PBCH block can be in OFDM symbol 7, the TSS associated with the second candidate SS/PBCH block can be in OFDM symbol 4, the TSS associated with the third candidate SS/PBCH block can be in OFDM symbol 5, the TSS associated with the fourth candidate SS/PBCH block can be in OFDM symbol 6, the TSS associated with the fifth candidate SS/PBCH block can be in OFDM symbol 51, the TSS associated with the sixth candidate SS/PBCH block can be in OFDM symbol 48, the TSS associated with the seventh candidate SS/PBCH block can be in OFDM symbol 49, the TSS associated with the eighth candidate SS/PBCH block can be in OFDM symbol 50.
For yet another instance, the TSS associated with the first candidate SS/PBCH block can be in OFDM symbol 4, the TSS associated with the second candidate SS/PBCH block can be in OFDM symbol 5, the TSS associated with the third candidate SS/PBCH block can be in OFDM symbol 6, the TSS associated with the fourth candidate SS/PBCH block can be in OFDM symbol 7, the TSS associated with the fifth candidate SS/PBCH block can be in OFDM symbol 48, the TSS associated with the sixth candidate SS/PBCH block can be in OFDM symbol 49, the TSS associated with the seventh candidate SS/PBCH block can be in OFDM symbol 50, the TSS associated with the eighth candidate SS/PBCH block can be in OFDM symbol 51.
For yet another instance, the TSS associated with the first candidate SS/PBCH block can be in OFDM symbol 27, the TSS associated with the second candidate SS/PBCH block can be in OFDM symbol 26, the TSS associated with the third candidate SS/PBCH block can be in OFDM symbol 25, the TSS associated with the fourth candidate SS/PBCH block can be in OFDM symbol 24, the TSS associated with the fifth candidate SS/PBCH block can be in OFDM symbol 51, the TSS associated with the sixth candidate SS/PBCH block can be in OFDM symbol 50, the TSS associated with the seventh candidate SS/PBCH block can be in OFDM symbol 49, the TSS associated with the eighth candidate SS/PBCH block can be in OFDM symbol 48.
For yet another instance, the TSS associated with the first candidate SS/PBCH block can be in OFDM symbol 27, the TSS associated with the second candidate SS/PBCH block can be in OFDM symbol 24, the TSS associated with the third candidate SS/PBCH block can be in OFDM symbol 25, the TSS associated with the fourth candidate SS/PBCH block can be in OFDM symbol 26, the TSS associated with the fifth candidate SS/PBCH block can be in OFDM symbol 51, the TSS associated with the sixth candidate SS/PBCH block can be in OFDM symbol 48, the TSS associated with the seventh candidate SS/PBCH block can be in OFDM symbol 49, the TSS associated with the eighth candidate SS/PBCH block can be in OFDM symbol 50.
For yet another instance, the TSS associated with the first candidate SS/PBCH block can be in OFDM symbol 24, the TSS associated with the second candidate SS/PBCH block can be in OFDM symbol 25, the TSS associated with the third candidate SS/PBCH block can be in OFDM symbol 26, the TSS associated with the fourth candidate SS/PBCH block can be in OFDM symbol 27, the TSS associated with the fifth candidate SS/PBCH block can be in OFDM symbol 48, the TSS associated with the sixth candidate SS/PBCH block can be in OFDM symbol 49, the TSS associated with the seventh candidate SS/PBCH block can be in OFDM symbol 50, the TSS associated with the eighth candidate SS/PBCH block can be in OFDM symbol 51.
For yet another instance, the TSS associated with the first candidate SS/PBCH block can be in OFDM symbol 27, the TSS associated with the second candidate SS/PBCH block can be in OFDM symbol 26, the TSS associated with the third candidate SS/PBCH block can be in OFDM symbol 25, the TSS associated with the fourth candidate SS/PBCH block can be in OFDM symbol 24, the TSS associated with the fifth candidate SS/PBCH block can be in OFDM symbol 31, the TSS associated with the sixth candidate SS/PBCH block can be in OFDM symbol 30, the TSS associated with the seventh candidate SS/PBCH block can be in OFDM symbol 29, the TSS associated with the eighth candidate SS/PBCH block can be in OFDM symbol 28.
For yet another instance, the TSS associated with the first candidate SS/PBCH block can be in OFDM symbol 27, the TSS associated with the second candidate SS/PBCH block can be in OFDM symbol 24, the TSS associated with the third candidate SS/PBCH block can be in OFDM symbol 25, the TSS associated with the fourth candidate SS/PBCH block can be in OFDM symbol 26, the TSS associated with the fifth candidate SS/PBCH block can be in OFDM symbol 31, the TSS associated with the sixth candidate SS/PBCH block can be in OFDM symbol 28, the TSS associated with the seventh candidate SS/PBCH block can be in OFDM symbol 29, the TSS associated with the eighth candidate SS/PBCH block can be in OFDM symbol 30.
For yet another instance, the TSS associated with the first candidate SS/PBCH block can be in OFDM symbol 24, the TSS associated with the second candidate SS/PBCH block can be in OFDM symbol 25, the TSS associated with the third candidate SS/PBCH block can be in OFDM symbol 26, the TSS associated with the fourth candidate SS/PBCH block can be in OFDM symbol 27, the TSS associated with the fifth candidate SS/PBCH block can be in OFDM symbol 28, the TSS associated with the sixth candidate SS/PBCH block can be in OFDM symbol 29, the TSS associated with the seventh candidate SS/PBCH block can be in OFDM symbol 30, the TSS associated with the eighth candidate SS/PBCH block can be in OFDM symbol 31.

For yet another example, time domain resources for TSS (e.g., an OFDM symbol index for the TSS) can be configured by a base station. For instance, the configuration can be provided by the 5G SSB, wherein for example, the configuration can be an OFDM symbol index (e.g., per SS/PBCH block index) or an instance index of this disclosure.

For yet another example, TSS has same bandwidth as PSS and/or SSS, e.g., 127 subcarriers mapped to a bandwidth of 12 RBs (e.g., wherein the starting subcarrier and ending subcarrier are aligned with PSS and/or SSS).

For yet another example, TSS has same bandwidth as 5G SS/PBCH block, e.g., 20 RBs. For one instance, the subcarriers for TSS are same as subcarriers of PSS and/or SSS in the bandwidth of 5G SS/PBCH block. For another instance, the remaining subcarriers in the symbol for TSS can be set to 0. For yet another instance, the lowest 48 subcarriers and/or highest 48 subcarriers in the symbol for TSS can be mapped for PBCH or additional PBCH (e.g., including the associated DM-RS of PBCH).

For yet another example, TSS has the same antenna port as 5G SS/PBCH block (e.g., PSS, SSS, PBCH).

For yet another example, one TSS is associated with a 5G SS/PBCH block, e.g., to make a 6G SS/PBCH block, and the TSS is quasi co-located (QCLed) with other signals in the 5G SS/PBCH block (e.g., PSS, SSS, DM-RS of PBCH), e.g., when an index of the TSS is same as an index of the SS/PBCH block (wherein an index of the TSS in indexed from low to high order in the time domain and within a period for SS/PBCH block burst transmission).

For yet another example, energy per resource element (EPRE) of TSS can be same as EPRE of SSS.

For yet another example, EPRE of TSS can be same as EPRE of PSS.

For yet another example, EPRE of TSS can be same as EPRE of PSS or same as EPRE of SSS.

For yet another example, EPRE of TSS can have a 0 dB or 3 dB offset to the EPRE of SSS.

In one sub-embodiment, a sequence generated for the TSS can be determined by the UE.

For one example, the sequence is based on a M-sequence.

For one instance, the M-sequence can be with a length of 127.

For another instance, the M-sequence can be binary phase-shift keying (BPSK) modulated and mapped to the subcarriers for the TSS.

For yet another instance, the M-sequence can use different cyclic shifts to carry information indicated by TSS, e.g., when there are N_{TSS} M-sequences for the TSS, the different cyclic shifts can be determined as {0, └L_{TSS}/N_{TSS}┘, 2·└L_{TSS}/N_{TSS}┘, . . . , (N_{TSS}−1)·└L_{TSS}/N_{TSS}┘} or Δ+¿{0, └L_{TSS}/N_{TSS}┘, 2·└L_{TSS}/N_{TSS}┘, . . . , (N_{TSS}−1)·└L_{TSS}/N_{TSS}┘}, where LTSS is the length of the M-sequence (e.g., L_{TSS}=127), and Δ is an integer (e.g., Δ=21 or 22).

For yet another instance, the M-sequence can use different initial conditions to carry information indicated by TSS.

For yet another instance, the M-sequence can use a generation function as x(i+7)=(x(i+4)+x(i))mod 2.

For yet another instance, the M-sequence can use a generation function as x(i+7)=(x(i+1)+x(i))mod 2.

For yet another instance, the M-sequence can use a generation function as x(i+7)=(x(i+6)+x(i))mod 2.

For yet another instance, the M-sequence can use a generation function as x(i+7)=(x(i+3)+x(i))mod 2.

For yet another instance, the M-sequence can use an initial condition as [x(6), x(5), x(4), x(3), x(2), x(1), x(0)]=[1, 1, 1, 0, 1, 1, 0].

For yet another instance, the M-sequence can use an initial condition as [x(6), x(5), x(4), x(3), x(2), x(1), x(0)]=[0, 0, 0, 0, 0, 0, 1].

For another example, the sequence is based on a Gold-sequence.

For one instance, the two M-sequences generating the Gold-sequence can be with a length of 127.

For another instance, the Gold-sequence can be BPSK modulated and mapped to the subcarriers for the TSS.

For yet another instance, at least one M-sequence generating the Gold-sequence can use different cyclic shifts to carry information indicated by TSS.

For yet another instance, at least one M-sequence generating the Gold-sequence can use different initial conditions to carry information indicated by TSS.

For yet another instance, at least one M-sequence generating the Gold-sequence can use a generation function as x(i+7)=(x(i+4)+x(i))mod 2.

For yet another instance, at least one M-sequence generating the Gold-sequence can use a generation function as x(i+7)=(x(i+1)+x(i))mod 2.

For yet another instance, least one M-sequence can use a generation function as x(i+7)=(x(i+6)+x(i))mod 2.

For yet another instance, least one M-sequence can use a generation function as x(i+7)=(x(i+3)+x(i))mod 2.

For yet another instance, at least one M-sequence (such as both of the M-sequences) generating the Gold-sequence can use an initial condition as [x(6), x(5), x(4), x(3), x(2), x(1), x(0)]=[0, 0, 0, 0, 0, 0, 1].

In one sub-embodiment, a UE (e.g., the UE 116) can determine indications carried by the TSS when receiving the TSS.

For one example, the presence of the TSS can indicate a 6G SS/PBCH block. For instance, if a UE receives an SS/PBCH block and does not receive the TSS associated with the SS/PBCH block, the UE expects the corresponding SS/PBCH block is a 5G SS/PBCH block; if a UE receives an SS/PBCH block and also receives the TSS associated with the SS/PBCH block, the UE expects the corresponding SS/PBCH block is a 6G SS/PBCH block.

For another example, an explicit indication of 5G or 6G can be carried the TSS. For instance, if a UE receives the TSS, the UE can determine whether the SS/PBCH block is for 5G or 6G based on the indication in TSS.

For yet another example, an indication of a (candidate) SS/PBCH block index or a part of the (candidate) SS/PBCH block index can be carried by the TSS. For one instance, the index can be a frequency domain index, indicating which frequency domain location is the associated SS/PBCH block. For another instance, the index can be most X (e.g., X=1, X=2, or X=3) significant bits (MSBs) of the (candidate) SS/PBCH block index, e.g., which extends the index of candidate SS/PBCH blocks carried by DM-RS of PBCH and/or payload of PBCH. For one implementation, this example can be applicable when the maximum number of the (candidate) SS/PBCH block index is greater than a threshold (e.g., 8 or 64).

For yet another example, an indication of whether the cell is accessible by a 6G device or certain type(s) of 6G device (e.g., whether the cell is barred for 6G UEs or type(s) of 6G UEs) can be carried by the TSS.

For yet another example, an indication of a cell ID or part of the cell ID can be carried by the TSS. For instance, the indication can be MSBs of the cell ID, which extends the number of cell IDs carried by PSS and/or SSS.

For yet another example, an indication of at least one parameter or configuration for physical downlink control channel (PDCCH) and/or physical downlink shared channel (PDSCH) for 6G system information (e.g., SIB1) can be carried by the TSS.
For one instance, the at least one parameter or configuration can include a subcarrier spacing.
For another instance, the at least one parameter or configuration can include a multiplexing pattern between SS/PBCH block and CORESET for monitoring PDCCH.
For yet another instance, the at least one parameter or configuration can include a number of symbols for the CORESET for monitoring PDCCH.
For yet another instance, the at least one parameter or configuration can include a number of resource blocks (RBs) for the CORESET for monitoring PDCCH.
For yet another instance, the at least one parameter or configuration can include a frequency offset (e.g., as a number of RBs) between SS/PBCH block and CORESET for monitoring PDCCH.
For yet another instance, the at least one parameter or configuration can include a frequency offset (e.g., as a number of RBs) between CORESET for monitoring PDCCH for 5G system information and CORESET for monitoring PDCCH for 6G system information.
For yet another instance, the at least one parameter or configuration can include a time offset (e.g., as a number of slots or symbols) between PDCCH for 5G system information and PDCCH for 6G system information.

For yet another example, an indication of at least one parameter or configuration for an additional PBCH or a secondary PBCH can be carried by the TSS.

In yet another embodiment, the UE or gNB adjusts operational parameters based on the identified RAT generation. For example, the operational parameters that may be adjusted upon identifying the RAT generation can include adjusting configuration(s) related to bandwidth parts. In another example, higher or lower sub-carrier spacing may be activated based on determining the RAT generation. In yet another example, dual connectivity operation may be triggered based on indication of the RAT generation. In yet another example, whether to enable rate matching around reserved resources (such as 5G reserved resources) for physical downlink shared channel (PDSCH) reception can be triggered based on the indication of the RAT generation. In yet another example, whether to enable operation(s) related to multi-RAT shared spectrum (MRSS) can be triggered based on the indication of the RAT generation.

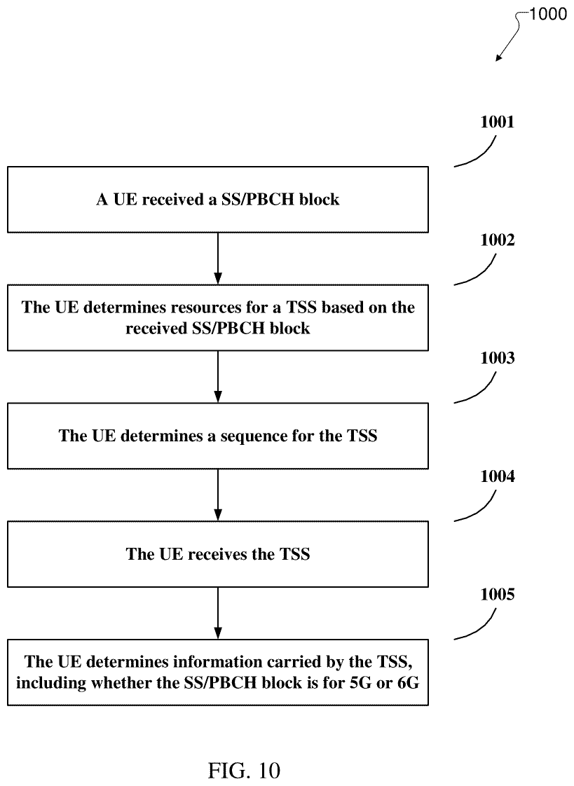

FIG. 10 illustrates an example UE procedure 1000 for determining information carried by a TSS according to embodiments of the present disclosure. For example, procedure 1000 can be performed by the UE 116 of FIG. 3. This example is for illustration only and other embodiments can be used without departing from the scope of the present disclosure.

The procedure begins in 1001, a UE received a SS/PBCH block. In 1002, the UE determines resources for a TSS based on the received SS/PBCH block. In 1003, the UE determines a sequence for the TSS. In 1004, the UE receives the TSS. In 1005, the UE determines information carried by the TSS, including whether the SS/PBCH block is for 5G or 6G.

In one sub-embodiment, an example UE procedure for receiving the TSS and acquiring the information carried by the TSS can be shown in FIG. 10.

With reference to FIG. 10, an example UE procedure is shown for receiving the TSS and acquiring information carried by the TSS.

In various embodiments, the UE receives a SS/PBCH block including a PSS and a SSS, identifies resources for a TSS associated with the SS/PBCH block, identifies whether the TSS is present in the resources, and determines to operate the wireless communication system with a first RAT when the TSS is present and a second RAT when the TSS is not present.

In various examples, the resources for the TSS are TDMed with the SS/PBCH block. In various examples, the resources for the TSS include 20 RBs in a frequency domain and 1 OFDM symbol in a time domain. In various examples, the TSS is QCLed with the SS/PBCH block. In various examples, the TSS has a same EPRE as the SSS.

In various embodiments, the UE detects a sequence associated with the TSS that is an M-sequence with a length of 127. In various embodiments, the UE receive the TSS and determines information carried by the TSS.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a synchronization signals and physical broadcast channel (SS/PBCH) block including a primary synchronization signal (PSS) and a secondary synchronization signal (SSS); and
a processor operably coupled to the transceiver, the processor configured to:
identify resources for a tertiary synchronization signal (TSS) associated with the SS/PBCH block;
identify whether the TSS is present in the resources; and
determine to operate the wireless communication system with (i) a first radio access technology (RAT) when the TSS is present and (ii) a second RAT when the TSS is not present.

2. The UE of claim 1, wherein the resources for the TSS are time division multiplexed (TDMed) with the SS/PBCH block.

3. The UE of claim 1, wherein the resources for the TSS include 20 resource blocks (RBs) in a frequency domain and 1 orthogonal frequency division multiplexing (OFDM) symbol in a time domain.

4. The UE of claim 1, wherein the TSS is quasi-co-located (QCLed) with the SS/PBCH block.

5. The UE of claim 1, wherein the TSS has a same energy per resource element (EPRE) as the SSS.

6. The UE of claim 1, wherein:
the processor is further configured to detect a sequence associated with the TSS, and
the sequence is an M-sequence with a length of 127.

7. The UE of claim 1, wherein:
the transceiver is further configured to receive the TSS; and
the processor is further configured to determine information carried by the TSS.

8. A base station (BS) in a wireless communication system, the BS comprising:
a processor configured to:
determine resources for a tertiary synchronization signal (TSS) associated with a synchronization signals and physical broadcast channel (SS/PBCH) block, the SS/PBCH block including a primary synchronization signal (PSS) and a secondary synchronization signal (SSS); and
determine to operate the wireless communication system with (i) a first radio access technology (RAT) or (ii) a second RAT; and
a transceiver operably coupled to the processor, the transceiver configured to:
transmit the SS/PBCH block;
transmit the TSS in the resources when the wireless communication system operates with the first RAT; and
not transmit the TSS in the resources when the wireless communication system operates with the second RAT.

9. The BS of claim 8, wherein the resources for the TSS are time division multiplexed (TDMed) with the SS/PBCH block.

10. The BS of claim 8, wherein the resources for the TSS include 20 resource blocks (RBs) in a frequency domain and 1 orthogonal frequency division multiplexing (OFDM) symbol in a time domain.

11. The BS of claim 8, wherein the TSS is quasi-co-located (QCLed) with the SS/PBCH block.

12. The BS of claim 8, wherein the TSS has a same energy per resource element (EPRE) as the SSS.

13. The BS of claim 8, wherein:
the processor is further configured to determine a sequence associated with the TSS, and
the sequence is an M-sequence with a length of 127.

14. The BS of claim 8, wherein:
the processor is further configured to determine information carried by the TSS; and
the transceiver is further configured to transmit the TSS.

15. A method of a user equipment (UE) in a wireless communication system, the method comprising:
receiving a synchronization signals and physical broadcast channel (SS/PBCH) block including a primary synchronization signal (PSS) and a secondary synchronization signal (SSS);
identifying resources for a tertiary synchronization signal (TSS) associated with the SS/PBCH block;
identifying whether the TSS is present in the resources; and
determining to operate the wireless communication system with (i) a first radio access technology (RAT) when the TSS is present and (ii) a second RAT when the TSS is not present.

16. The method of claim 15, wherein the resources for the TSS are time division multiplexed (TDMed) with the SS/PBCH block.

17. The method of claim 15, wherein the resources for the TSS include 20 resource blocks (RBs) in a frequency domain and 1 orthogonal frequency division multiplexing (OFDM) symbol in a time domain.

18. The method of claim 15, wherein the TSS is quasi-co-located (QCLed) with the SS/PBCH block.

19. The method of claim 15, wherein the TSS has a same energy per resource element (EPRE) as the SSS.

20. The method of claim 15, further comprising:
detecting a sequence associated with the TSS, the sequence being an M-sequence with a length of 127;
receiving the TSS; and
determining information carried by the TSS.
